(19) United States
(12) Patent Application Publication
(10) Pub. No.: US 2012/0028179 A1
(43) Pub. Date: Feb. 2, 2012

(54) ELECTROPHOTOGRAPHIC PHOTORECEPTOR, IMAGE FORMING METHOD, IMAGE FORMING APPARATUS, AND PROCESS CARTRIDGE FOR IMAGE FORMING APPARATUS USING THE PHOTORECEPTOR

(76) Inventors: Hongguo LI, Shizuoka (JP); Kazukiyo NAGAI, Shizuoka (JP); Tetsuro SUZUKI, Shizuoka (JP)

(21) Appl. No.: 13/156,750

(22) Filed: Jun. 9, 2011

(30) Foreign Application Priority Data
Jul. 29, 2010 (JP) 2010-170508

(51) Int. Cl. G03G 5/04; G03G 21/18; G03G 15/00; G03G 13/16

(52) U.S. Cl. 430/58.05; 430/125.3; 399/111; 399/159

(57) ABSTRACT

An electrophotographic photoreceptor, including an electroconductive substrate; a charge generation layer; a hole transport layer; and a hole transportable protection layer being a three-dimensional crosslinked film formed by irradiating at least a radical polymerizable hole transportable compound with UV to be chain-polymerized, layered in this order, wherein the hole transportable protection layer comprises a silole compound having the following formula (1):

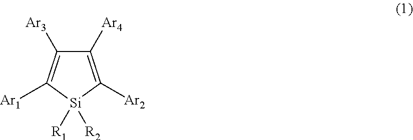

wherein each of R₁ and R₂ represents a monovalent alkyl group having 1 to 4 carbon atoms or a monovalent phenyl group; Each of Ar1 to Ar4 represents a phenyl group, a naphtyl group and a biphenylyl group or a phenyl group, a naphtyl group and a biphenylyl group substituted with a monovalent alkyl group having 1 to 4 carbon atoms and a trifluoromethyl group; and R₁, R₂ and Ar₁ to Ar₄ adjacent to each other optionally connect with each other to form rings.

### BACKGROUND OF THE INVENTION

1. Field of the Invention

The present invention relates to an image forming method and an image forming apparatus using an electrophotographic method capable of on-demand printing in commercial printing fields, and an electrophotographic photoreceptor and a process cartridge for the image forming apparatus used therein.

2. Discussion of the Background

In recent years, since on-demand printing is easy, an electrophotographic image forming apparatus which has become widely used in the office has begun to spread to the commercial printing field as well. In the commercial printing field, high-speed printing, large-scale printing, high image quality, paper responsiveness, and reduction in the cost of printed materials are demanded more than ever before.

In order to attain high speed-printing, large-scale printing, and reduction in the cost of printed materials, it is necessary that an electrophotographic photoreceptor which is a central device of electrophotography be durable and have a long shelf life. As photoreceptors, both an inorganic photoreceptor, a representative of which is amorphous silicon, and an organic photoreceptor including an organic charge generation material and an organic charge transport material, are used. However, organic photoreceptors are thought to be superior for several reasons, including (I) optical properties such as a width of a light absorbing wavelength region and a magnitude of an absorption amount, (II) high sensitivity, and electric properties such as safe electrostatic charging properties, (III) a wide selection range of materials, (IV) ease of manufacturing, (V) low cost, and (VI) non-toxicity, etc. On the other hand, the organic photoreceptors are susceptible to scratches that can cause image defects and abrasions that can cause deterioration in sensitivity, deterioration in electrostatic charging properties, and charge leakage, all of which can cause abnormal images such as reduction in image density and background staining.

As a means of improving the scratch resistance and abrasion resistance of the organic photoreceptors, a photoreceptor in which a mechanically tough protection layer is formed on the previous organic photoreceptor is proposed. For example, Japanese published unexamined application No. 2000-66425 discloses a photosensitive layer containing a compound in which a hole transport compound having two or more chain polymerizable functional groups in the same molecule is cured.

For example, Japanese published unexamined applications Nos. 2006-113321 and 2004-302451, and Japanese Patent No. 4145820 disclose a photoreceptor having, as a protection layer, a crosslinked film obtained by irradiating a composition obtained by mixing a radical polymerizable charge transportable compound, a tri- or more functional radical polymerizable monomer, and a photopolymerization initiator with ultraviolet (UV) radiation to conduct a radical curing reaction. Since this photoreceptor has excellent scratch resistance and abrasion resistance as well as excellent environmental stability, it can output an image stably without using a drum heater.

In addition, Japanese published unexamined applications No. 2004-302452 discloses preventing deterioration of a photosensitive material during photoreceptor manufacturing by containing an UV absorber in the crosslinked film, in order to prevent reduction in electric properties due to UV radiation.

These related arts have proved that a photoreceptor having a protection layer formed by three-dimensionally crosslinking a radical polymerizable charge transportable compound (particularly a charge transportable compound having an acrylic group) solely or with other acrylic monomers has good scratch resistance, abrasion resistance, electrical properties, and is suitable for mass commercial printing. However, recent commercial printing has required higher quality images than ever, and therefore potential variation and uneven potential of the photoreceptor as time passes need prevention. However, the above photoreceptors do not have sufficient properties.

The protection layer needs to include a photodegradable radical polymerization initiator and be irradiated with light (particularly an UV) irradiation. Alternatively, the protection layer needs to be irradiated with a high-energy electron or radiation ray to directly excite the acrylic group and initiate polymerization. In whichever way, the charge transportable compound in the protection layer is excited at the same time and partially resolves, which is thought to result in deterioration of important charge transportability of the photoreceptor.

In order to solve this problem, an UV absorber is thought to be included in the protection layer as Japanese published unexamined applications No. 2004-302452 discloses. However, conventional UV absorbers have adverse effects of largely deteriorating charge transportability, and preventing radical polymerization reaction at the same time, resulting in formation of a protection layer having insufficient crosslinked density.

A singlet oxygen quencher such as nickel dithiolate complexes is known as an additive which prevents a pigment from resolving. However, the additive in a protection layer makes a photoreceptor totally lose its photoconductivity.

Improvement of such problems due to the protection layer of a photoreceptor, which formed by three-dimensionally crosslinking at least a radical polymerizable charge transportable compound with an UV ray has not been made to meet with demand for high-quality images (image density stability as time passes) in commercial printing fields.

Because of these reasons, a need exists for an electrophotographic photoreceptor including a protection layer having better charge transportability, capable of producing higher quality images than ever while having sufficient scratch and abrasion resistance.

### SUMMARY OF THE INVENTION

Accordingly, an object of the present invention is to provide an electrophotographic photoreceptor including a protection layer having better charge transportability, capable of producing higher quality images than ever while having sufficient scratch and abrasion resistance.

Another object of the present invention is to provide an image forming method using the photoreceptor.

A further object of the present invention is to provide an image forming apparatus using the photoreceptor.

Another object of the present invention is to provide a process cartridge using the photoreceptor. These objects and other objects of the present invention, either individually or collectively, have been satisfied by the discovery of an electrophotographic photoreceptor, comprising:

an electroconductive substrate;

a charge generation layer overlying the substrate;

a hole transport layer overlying the charge generation layer; and

a hole transportable protection layer overlying the hole transport layer, the transportable protection layer being a three-dimensional crosslinked film formed by irradiating at least a radical polymerizable hole transportable compound with UV to be chain-polymerized,

wherein the hole transportable protection layer comprises a silole compound having the following formula (1):

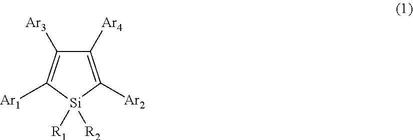

wherein each of R₁ and R₂ represents a monovalent alkyl group having 1 to 4 carbon atoms or a monovalent phenyl group; Each of Ar1 to Ar4 represents a phenyl group, a naphtyl group and a biphenylyl group or a phenyl group, a naphtyl group and a biphenylyl group substituted with a monovalent alkyl group having 1 to 4 carbon atoms and a trifluoromethyl group; and R₁, R₂ and Ar₁ to Ar₄ adjacent to each other optionally connect with each other to form rings.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a cross-sectional view illustrating an embodiment of the electrophotographic photoreceptor of the present invention;

FIG. 2 is a schematic view illustrating an embodiment of the image forming apparatus of the present invention;

FIG. 3 is a schematic view illustrating an embodiment of the process cartridge for the image forming apparatus of the present invention;

FIG. 4 is a schematic view illustrating a method of measuring elastic displacement with a microscopic surface hardness meter; and

FIG. 5 is a diagram showing a relation between plastic displacement and elastic displacement relative to a load.

### DETAILED DESCRIPTION OF THE INVENTION

The present invention provides an electrophotographic photoreceptor including a protection layer having better charge transportability, capable of producing higher quality images than ever while having sufficient scratch and abrasion resistance.

More particularly, the present invention provides an electrophotographic photoreceptor, comprising:

an electroconductive substrate;

a charge generation layer overlying the substrate;

a hole transport layer overlying the charge generation layer; and

a hole transportable protection layer overlying the hole transport layer, the transportable protection layer being a three-dimensional crosslinked film formed by irradiating at least a radical polymerizable hole transportable compound with UV to be chain-polymerized,

wherein the hole transportable protection layer comprises a silole compound having the following formula (I):

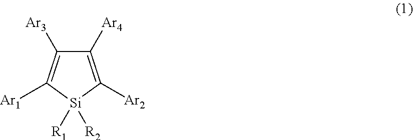

wherein each of R₁ and R₂ represents a monovalent alkyl group having 1 to 4 carbon atoms or a monovalent phenyl group; Each of Ar1 to Ar4 represents a phenyl group, a naphtyl group and a biphenylyl group or a phenyl group, a naphtyl group and a biphenylyl group substituted with a monovalent alkyl group having 1 to 4 carbon atoms and a trifluoromethyl group; and R₁, R₂ and Ar₁ to Ar₄ adjacent to each other optionally connect with each other to form rings.

A photoreceptor capable of forming an image of high quality demanded in commercial printing is required to have such in-plane potential uniformity that, when the same light writing is performed, a potential becomes the same potential at any place, and potential retainability such that charge and irradiation potential are same, and it is necessary to prevent unevenness of not only thickness and quality of crosslinked protection layer but also charge trap therein.

Even when elusion of constituent materials etc. of a lower layer onto a crosslinked protection layer is prevented and a uniform coated film is formed, the protection layer is unevenly irradiated due to equipment conditions when a high-energy beam is irradiated thereto to start crosslinking thereof. When an UV is irradiated with a photopolymerization initiator, a lamp boundary region of an UV irradiator and light reflection therein cause uneven UV irradiation to the surface of a photoreceptor, resulting in uneven thickness and quality of a crosslinked layer. The uneven light irradiation is thought to cause uneven crosslink density of the crosslinked protection layer. The light irradiation is increased to avoid uneven crosslink density, but which does not have an apparent effect. Rather, the increased light irradiation causes deterioration of properties of a photoreceptor. The uneven irradiation is thought to cause production of photolytes by the radical polymerizable charge transportable compound assuming transportability in the protection layer rather than uneven crosslink density.

Therefore, prevention of the photolyte can be thought to prevent the charge trap and uneven charge which deteriorate the potential uniformity and retainability in the protection layer.

As a result of keen studies of the preset inventors, they found a silole derivative effectively prevents the photolyte and does not disturb curing polymerization reaction in irradiation of a high-energy beam such as UV. The mechanism is not clarified, but it is thought a radical polymerizable hole transportable compound excited by the high-energy beam and a specific silole derivative form an intermolecular exciplex aggregate, which is deactivated to prevent the excited radical polymerizable charge transportable compound from resolving.

Further, the silole derivative has an oxidation potential larger than that of the radical polymerizable hole transportable compound, and therefore, it is not a hole trap and does not decrease the hole transportability. In addition, the silole derivative has a short absorption wavelength and absorbs less UV needed for initiating polymerization, which does not disturb the cross-linking reaction. Further, the silole derivative has an excitation potential level lower than that of the radical polymerizable hole transportable compound and the exciplex aggregate is easily formed. Therefore, it is thought production of the photolytes by the radical polymerizable hole transportable compound in irradiation of a high-energy beam such as UV and generation of the charge trap in the protection layer can be prevented without deterioration of basic electrical and mechanical properties of a photoreceptor.

The prevention of generation of the charge trap in the protection layer even reduces influence of uneven UV irradiation and improves the in-plane potential uniformity and stability of a photoreceptor.

Such an electrophotographic photoreceptor can produce high-quality images having good image density uniformity.

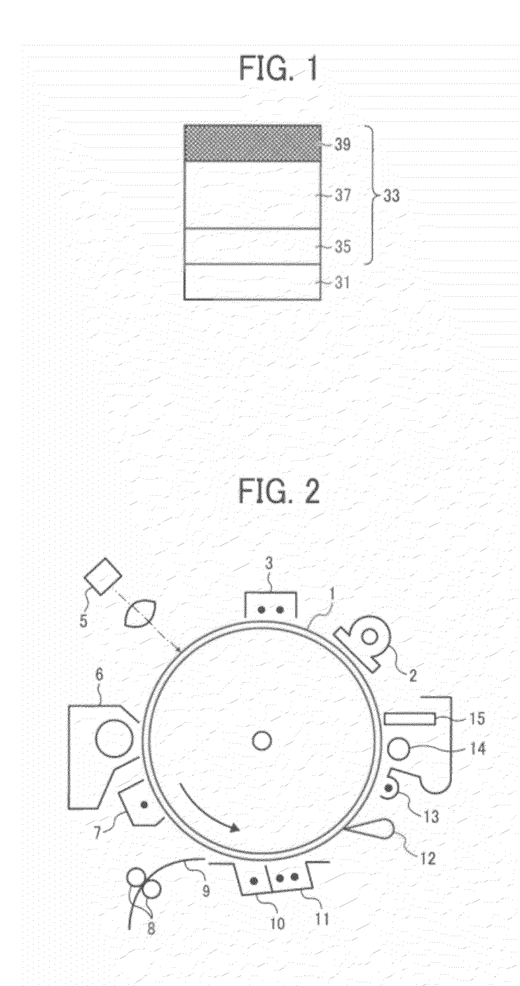

The present invention will be described below in accordance with its layer structure. FIG. 1 is a cross-sectional view of the electrophotographic photoreceptor of the present invention, and the photoreceptor is a photoreceptor having a laminated structure in which a charge generation layer (35) having a charge generation function, a hole transport layer (37) and, further, a hole transportable protection layer (39) are laminated on an electroconductive substrate (31). These four layers are essential constitution and, furthermore, one layer or a plurality of layers of undercoat layers may be inserted between the electroconductive substrate (31) and the charge generation layer (35). In addition, a layer constituting part including the charge generation layer (35), the hole transport layer (37) and the hole transportable protection layer (39) is referred to as a photosensitive layer (33).

### <Electroconductive Substrate>

As the electroconductive substrate (31), known electroconductive substrates can be used. The substrate may be aluminum, nickel etc. exhibiting electrical conductivity of a volume resistance of 10¹⁰ Ω·cm or less, and an aluminum drum, an aluminum-deposited film, a nickel belt etc. are preferably used. For high image quality in the commercial printing field, since the dimensional precision of a photoreceptor is strictly required, a substrate obtained by subjecting an aluminum drum manufactured by a drawing method to cutting and polishing processing to improve the smoothness of a surface and dimensional precision is preferable. In addition, as the nickel belt, an endless nickel belt disclosed in JP-A No. 52-36016 gazette can be used.

### <Charge Generation Layer>

As the charge generation layer (35), a charge generation layer which has been used in the previous organic electrophotographic photoreceptor can be used as it is. That is, it is a layer containing a charge generation material having the charge generation function as a main component and, if necessary, a binder resin can be used together. Preferable charge generation materials are, for example, phthalocyanine-based pigments such as metal phthalocyanine and metal-free phthalocyanine, and azo pigments and, as the metal phthalocyanine, titanyl phthalocyanine, chlorogallium phthalocyanine, hydroxygallium phthalocyanine, etc. are used. These charge generation materials can be used alone or in combination.

Examples of the binder resin which is used as necessary include polyamide, polyurethane, an epoxy resin, polyketone, polycarbonate, a silicone resin, an acrylic resin, polyvinyl butyral, polyvinyl formal, polyvinyl ketone, polystyrene, poly-N-vinylcarbazole, and polyacrylamide. These binder resins can be used alone or in combination.

The charge generation layer (35) can be formed, for example, by dispersing the charge generation material with a ball mill, an attritor, a sand mill, a bead mill etc. using, if necessary, the binder resin together with a solvent such as tetrahydrofuran, dioxane, dioxolane, toluene, dichloromethane, monochlorobenzene, dichloroethane, cyclohexanone, cyclopentanone, anisole, xylene, methyl ethyl ketone, acetone, ethyl acetate, butyl acetate etc., and appropriately diluting and coating the dispersion. In addition, if necessary, a leveling agent such as a dimethyl silicone oil or a methyl phenyl silicone oil can be added. Coating can be performed using a dip coating method, a spray coating, bead coating, or ring coating method. The thus formed charge generation layer suitably has a thickness of from 0.01 to 5 μm, and preferably from 0.05 to 2 μm.

### <Hole Transport Layer>

As the hole transport layer, a known charge transport layer in which a charge transport material is dispersed in a binder resin can be used. As the hole transport material, known hole transport materials can be used. Examples thereof include an oxazole derivative, an imidazole derivative, a monoarylamine derivative, a diarylamine derivative, a triarylamine derivative, a stilbene derivative, an α-phenylstilbene derivative, a benzidine derivative, a diarylmethane derivative, a triarylmethane derivative, a 9-styrylanthracene derivative, a pyrazoline derivative, a divinylbenzene derivative, a hydrazone derivative, an indene derivative, a butadiene derivative, a pyrene derivative, a bisstilbene derivative and an enamine derivative. These can be used alone or in combination.

Examples of the binder resin include thermoplastic or thermosetting resins such as polystyrene, a styrene-acrylonitrile copolymer, a styrene-butadiene copolymer, a styrene-maleic anhydride copolymer, polyester, polyvinyl chloride, a vinyl chloride-vinyl acetate copolymer, polyvinyl acetate, polyvinylidene chloride, a polyacrylate resin, a phenoxy resin, polycarbonate, a cellulose acetate resin, an ethylcellulose resin, polyvinyl butyral, polyvinyl formal, polyvinyltoluene, poly-N-vinylcarbazole, an acrylic resin, a silicone resin, an epoxy resin, a melamine resin, a urethane resin, a phenol resin and an alkyd resin. It is suitable that the amount of the charge transport material is 20 to 300 parts by weight, preferably 40 to 150 parts by weight relative to 100 parts by weight of the binder resin. As a solvent used in coating of the hole transport layer, the same solvent for the charge generation layer can be used, and a solvent which dissolves the charge transport material and the binder resin well is suitable. These solvents may be used alone or in combination. In addition, for formation, the same coating methods as those for the charge generation layer (35) can be used.

In addition, if necessary, a plasticizer and a leveling agent may be added. As the plasticizer which can be used together in the hole transport layer, a plasticizer which is used as a plasticizer of general resins such as dibutyl phthalate and dioctyl phthalate can be used as it is and the amount thereof used is suitably around 0 to 30 parts by weight relative to 100 parts by weight of the binder resin. As the leveling agent which can be used together in the charge transport layer, silicone oils such as a dimethylsilicone oil and a methylphenylsilicone oil, and polymers or oligomers having a perfluoroalkyl group on a side chain are used, and it is suitable that the amount thereof used is around 0 to 1 part by weight relative to 100 parts by weight of the binder resin.

It is suitable that the hole transport suitably has a thickness of from 5 to 40 μm, and preferably from 10 to 30 μm. A hole transportable protection layer is formed on the thus formed hole transport layer.

### <Hole Transportable Protection Layer>

The hole transportable protection layer of the present invention is a three-dimensional crosslinked film formed by irradiating at least a radical polymerizable hole transportable compound with a high-energy ray to be chain-polymerized, and includes a specific silole compound.

The specific silole compound which is an essential material in the present invention has the following formula (I):

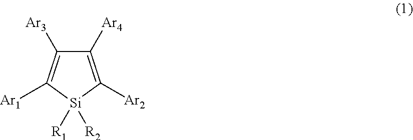

wherein each of R₁ and R₂ represents a monovalent alkyl group having 1 to 4 carbon atoms or a monovalent phenyl group; Each of Ar1 to Ar4 represents a phenyl group, a naphtyl group and a biphenylyl group or a phenyl group, a naphtyl group and a biphenylyl group substituted with a monovalent alkyl group having 1 to 4 carbon atoms and a trifluoromethyl group; and R₁, R₂ and Ar₁ to Ar₄ adjacent to each other optionally connect with each other to form rings.

Preferred Examples of the monovalent alkyl group having 1 to 4 carbon atoms include a methyl group, an ethyl group, a 1-propyl group, a 2-propyl group, a n-butyl group, a sec-butyl group, an isobutyl group and a tert-butyl group. Ar₁ to Ar₄ include a phenyl group, a 1-naphtyl group, a 2-naphtyl group, an o-biphenylyl group, a m-biphenylyl group, a p-biphenylyl group or these substituted with an alkyl group having 1 to 4 carbon atoms and a trifluoromethyl group.

Specific examples of the silole compound having the formula (1) include, but not limited to, the following compounds.

TABLE 1-1
(1)

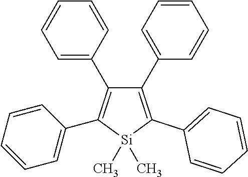

(2)

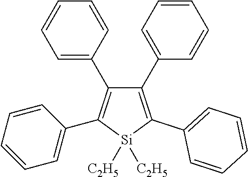

(3)

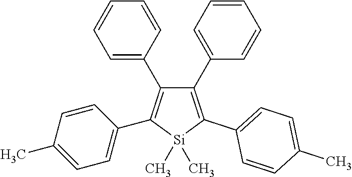

(4)

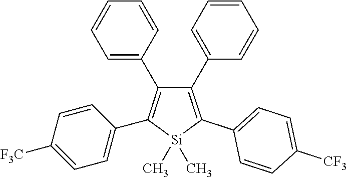

(5)

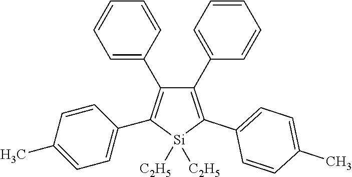

(6)

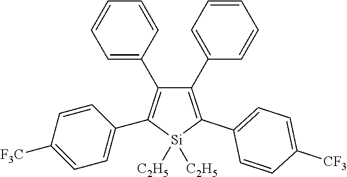

(7)

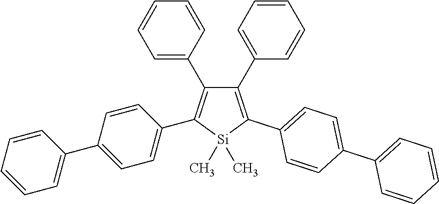

(8)

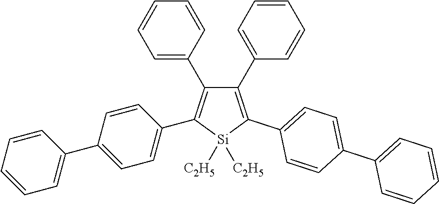

TABLE 1-2
(9)

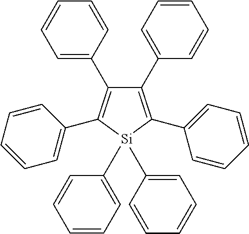

(10)

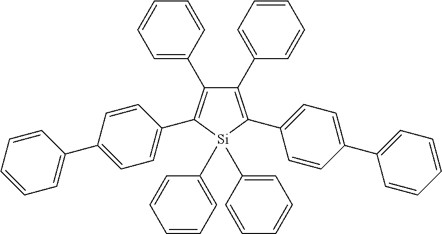

(11)

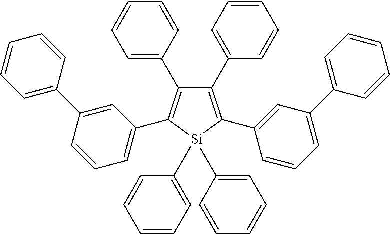

(12)

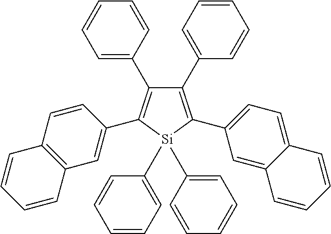

(13)

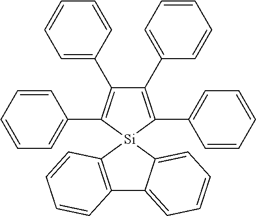

(14)

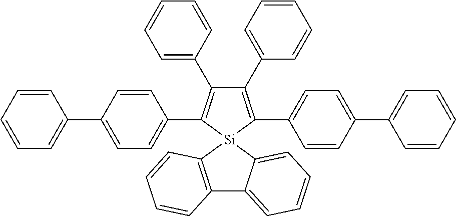

(15)

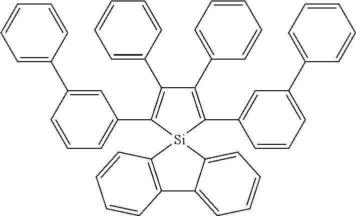

The hole transportable protection layer includes the silole compounds in an amount of from 0.1 to 30% by weight. When too little, potential variation is not effectively reduced. When too much, the resultant photoreceptor deteriorates in sensitivity.

As mentioned above, the silole compound does not have hole transportability, and dilutes a hole transportable compound and deteriorates charge transportability when included too much in a protection layer, resulting in deterioration of sensitivity. Further, when included too much, crosslink density by radical polymerization deteriorates, resulting in deterioration of mechanical strength and abrasion resistance of a protection layer. Therefore, the silole compound is preferably included as little as possible to exert an effect, and more preferably included in a protection layer in an amount of from 0.5 to 10% by weight based on total weight of a radical polymerizable hole transportable compound to clearly prevent generation of charge trap and have less adverse effect in the protection layer.

Next, a method of forming a hole transportable protection layer and compositions besides the silole compound will be explained.

The hole transportable protection layer of the present invention is three-dimensionally crosslinked by mainly polymerizing a radical polymerizable hole transportable compound under the following conditions:

(1) mixing a radical polymerizable hole transportable compound having one radical polymerizable functional group with a multifunctional radical polymerizable monomer having two or more radical polymerizable functional groups in a molecule to be polymerized; and

(2) polymerizing a radical polymerizable hole transportable compound having two or more radical polymerizable functional groups alone or mixing this with a radical polymerizable monomer having one or more radical polymerizable functional groups in a molecule to be polymerized.

A three-dimensional crosslinked film can be formed by radical chain polymerizing by the above conditions. Radical polymerization of a compound having only one polymerizable functional group just forms a linear polymer. Even when it is insoluble by entanglement of molecular chains, the resultant crosslinked film does not have good abrasion resistance.

Further, preferably mixing a radical polymerizable hole transportable compound having one radical polymerizable functional group with a multifunctional radical polymerizable monomer having three or more radical polymerizable functional groups in a molecule to be polymerized. This is because the radical polymerizable hole transportable compound needs to have a high compositional ratio to increase hole transportability of a protection layer, in such a case, the more the number of the functional groups of the multifunctional radical polymerizable monomer, the inure advantageous to form a film having high crosslink density and good mechanical strength.

In the present invention, a high-energy ray such as UV is irradiated to form a crosslinked film, i.e., a hole transportable protection layer. This is because a film having a higher crosslink density and a larger elastic power than that formed by heat polymerization with a heat polymerization initiator, etc., which is essential for the protection layer of the present invention to have enough abrasion resistance. Therefore, the high irradiation energy causes excitation of the hole transportable structure, which is a problem of the present invention.

Ordinarily, to prevent a material from resolving due to the high irradiation energy, oxygen density is reduced in a nitrogen gas or increase of temperature in irradiation is prevented, which can be used in the present invention as well.

It is conventionally known that a radical polymerizable hole transportable compound having one functional is mixed with tri- or more functional radical polymerizable monomer with a photopolymerization initiator to be polymerized by UV irradiation and form a three-dimensional crosslinked film, which is a hole transportable protection layer having good hole transportability and abrasion resistance. This is preferably used in the present invention as well.

Namely, a monofunctional radical polymerizable hole transportable compound, a tri- or more radical polymerizable monomer, a photopolymerization initiator and the silole compound are dissolved in a proper solvent to prepare a solution, and after the solution is coated on a hole transport layer, an UV ray is irradiated to the coated solution to be crosslinked and form a most suitable hole transportable protection layer.

The coating solution, when the radical polymerizable monomer is a liquid, can also be coated by dissolving other components in this solution, but if necessary, is coated by diluting with a solvent as mentioned above.

Examples of the solvent used thereupon include alcohol series such as methanol, ethanol, propanol, and butanol, ketone series such as acetone, methyl ethyl ketone, methyl isobutyl ketone, and cyclohexanone, ester series such as ethyl acetate, and butyl acetate, ether series such as tetrahydrofuran, dioxane, and propyl ether, halogen series such as dichloromethane, dichloroethane, trichloroethane, and chlorobenzene, aromatic series such as benzene, toluene, and xylene, and cellosolve series such as methyl cellosolve, ethyl cellosolve, and cellosolve acetate. These solvents may be used alone, or by mixing two or more kinds of them. The rate of dilution with a solvent is different depending on solubility of a composition, a coating method, and an objective film thickness, and is optional. Coating can be performed using a dip coating method, a spray coating, bead coating, ring coating method.

An UV irradiation light source such as a high pressure mercury lamp or a metal halide lamp having a light emission wavelength mainly in ultraviolet light can be utilized. An irradiation light level is preferably 50 mW/cm² or more and 1000 mW/cm² or less and, when the level is less than 50 mW/cm², the curing reaction takes a time. When the level is more intense than 1000 mW/cm², the progress of the reaction becomes ununiform, and irregularities are formed on the crosslinked surface layer and electric properties deteriorate.

Herein, with respect to the radical polymerizable charge transport compound, the tri- or more functional radical polymerizable monomer, the photopolymerization initiator, the coating solvent, the coating method, the drying method, the ultraviolet irradiation condition etc., previously known materials and methods can be applied. For example, the charge transport compounds having a radical polymerizable functional group, the tri- or more functional radical polymerizable monomers having no charge transport structure, bifunctional radical polymerizable monomers and the photopolymerization initiators described in JP-A No. 2005-266513 gazette, JP-A No. 2004-302452 gazette, and U.S. Pat. No. 4,145,820 gazette can be used corresponding to the radical polymerizable hole transportable compound, the multifunctional radical polymerizable monomer, and the photopolymerization initiator of the present invention, and the coating solvent, the coating method, the drying method, and the ultraviolet ray irradiation condition described in these prior applications can be applied.

That is, the radical polymerizable functional hole transportable compound of the present invention refers to a compound having a hole transport structure such as triarylamine, hydrazone, pyrazoline, and carbazole, for example, an electron transport structure such as an electron withdrawing aromatic ring having fused polycyclic quinone, diphenoquinone, a cyano group or a nitro group, and having a radical polymerizable functional group. As this radical polymerizable functional group, particularly, an acryloyloxy group and a methacryloyloxy group are useful. The number of radical polymerizable functional groups in one molecule may be at least one, but in order to suppress internal stress of a crosslinked surface layer to easily obtain smooth surface properties, and in order to maintain good electric properties, it is preferable that the radical polymerizable functional group is one. When the charge transport compound has two or more radical polymerizable functional groups, the room degree thereof may be reduced from great strain due to fixation of a bulky hole transporting compound in a crosslinking bond with a plurality of bonds, and irregularity, cracking or film peeling may occur from a charge transport structure and the number of functional groups. In addition, an intermediate structure (cation radical) during charge transportation cannot be retained stably due to this great strain, a reduction in sensitivity and an increase in a residual potential due to trapping of a charge become easy to occur. As a charge transport structure of the charge transport compound having a radical polymerizable functional group, a triarylamine structure is preferable from high mobility.

The charge transport compound having a radical polymerizable functional group used in the present invention is important for imparting the charge transport performance to a crosslinked surface layer, and the content of a coating solution component is adjusted so that this component is 20 to 80% weight, preferably 30 to 70% by weight relative to the total crosslinked surface layer amount. When this component is less than 20% by weight, the charge transport performance of a crosslinked surface layer cannot be sufficiently retained, and deterioration of electric properties such as reduction in sensitivity and an increase in a residual potential appears by repetitive use. In addition, when the amount exceeds 80% by weight, the content of a trifunctional monomer having no charge transport structure is reduced, this easily leads to reduction in a crosslinking bond density, and high abrasion resistance is not exerted. Since required electric properties and abrasion resistance are different depending on a process used, it cannot be said unconditionally, but in view of balance between both properties, the range of 30 to 70% by weight is most preferable.

The multifunctional radical polymerizable monomer used in the present invention refers to a monomer having no hole transport structure such as triarylamine, hydrazone, pyrazoline, and carbazole, for example, no electron transport structure such as an electron withdrawing aromatic ring having fused polycyclic quinone, diphenoquinone, a cyano group or a nitro group, and having three or more radical polymerizable functional groups. This radical polymerizable functional group may be any group which has a carbon-carbon double bond, and is radical-polymerizable. Examples thereof include trimethylolpropane triacrylate (TMPTA), trimethylolpropane trimethacrylate, trimethylolpropanealkylene-modified triacrylate, trimethylolpropaneethyleneoxy-modified (hereafter EO-modified) triacrylate, trimethylolpropanepropyleneoxy-modified (hereafter PO-modified) triacrylate, trimethylolpropanecaprolactone-modified triacrylate, trimethylolpropanealkylene-modified trimethacrylate, pentaerythritol triacrylate, pentaerythritol tetracrylate (PETTA), glycerol triacrylate, glycerol epichlorohydrin-modified (hereafter ECH-modified) triacrylate, glycerol EO-modified triacrylate, glycerol PO-modified triacrylate, tris(acryloxyethyl) isocyanurate, dipentaerythritol hexaacrylate (DPHA), dipentaerythritolcaprolactone-modified hexaacrylate, dipentaerythritolhydroxy pentaacrylate, alkylated dipentaerythritol pentacrylate, alkylated dipentaerythritol tetraacrylate, alkylated dipentaerythritol triacrylate, dimethylolpropane tetraacrylate (DTMPTA), pentaerythritolethoxy tetraacrylate, phosphoric acid EO-modified triacrylate, and 2,2,5,5-tetrahydroxymethylcyclopentanone tetracrylate. These can be used alone or in combination.

As the multifunctional radical polymerizable monomer, the ratio of a molecular weight relative to the functional group number in the monomer (molecular weight/functional group number) is desirably 250 or less, in order to form a dense crosslinking bond in a crosslinked surface layer. In addition, when this ratio is greater than 250, since the crosslinked surface layer is soft, and abrasion resistance is reduced to some extent, it is not preferable to use a monomer having an extreme long modified group alone, in a monomer having a modified group such as EO, PO or caprolactone. In addition, a content in a coating solution solid matter is adjusted, so that the component ratio of the tri- or more functional radical polymerizable monomer having no charge transport structure used in a surface layer becomes 20 to 80% by weight, preferably 30 to 70% by weight relative to the total amount of the crosslinked surface layer. When the monomer component is less than 20% by weight, the three-dimensional crosslinking bond density of the crosslinked surface layer is small, and dramatic improvement in abrasion resistance is not attained as compared with a previous case using a thermoplastic binder resin. Further, when the monomer component exceeds 80% by weight, the content of the charge transport compound is reduced, and deterioration in the electric properties is generated. Since required abrasion resistance and electric properties are different depending on a process used, it cannot be said unconditionally, but in view of balance between both properties, the range of 30 to 70% by weight is most preferable.

The photopolymerization initiator used in the present invention is not particularly limited as far as it is a polymerization initiator which easily generates a radical by light, and examples thereof include acetophenone-based or ketal-based photopolymerization initiators such as diethoxyacetophenone,
2,2-dimethoxy-1,2-diphenylethane-1-one,
1-hydroxy-cyclohexyl-phenyl-ketone,
4-(2-hydroxyethoxy)phenyl-(2-hydroxy-2-propyl)ketone,
2-benzyl-2-dimethylamino-1-(4-morpholinophenyl)butanone-1,2-hydroxy-2-methyl-1-phenylpropane-1-one,
2-methyl-2-morpholino(4-methylthiophenyl)propane-1-one, and
1-phenyl-1,2-propanedione-2-(o-ethoxycarbonyl)oxime,
benzoin ether-based photopolymerization initiators such as benzoin, benzoin methyl ether, benzoin ethyl ether, benzoin isobutyl ether, and benzoin isopropyl ether, benzophenone-based photopolymerization initiators such as benzophenone, 4-hydroxybenzophenone, methyl o-benzoylbenzoate, 2-benzoylnaphthalene, 4-benzoylbiphenyl, 4-benzoyl phenyl ether, acrylated benzophenone, and 1,4-benzoylbenzene, thioxanthone-based photopolymerization initiators such as 2-isopropylthioxanthone, 2-chlorothioxanthone, 2,4-dimethylthioxanthone, 2,4-diethylthioxanthone, and 2,4-dichlorothioxanthone and, additional other photopolymerization initiators such as ethylanthraquinone, 2,4,6-trimethylbenzoyldiphenylphosphine oxide, 2,4,6-trimethylbenzoylphenylethoxyphosphine oxide, bis(2,4,6-trimethylbenzoyl)phenylphosphine oxide, bis(2,4-dimethoxybenzoyl)-2,4,4-trimethylpentylphosphine oxide, methyl phenyl glyoxy ester, 9,10-phenanthrene, acridine-based compound, triazine-based compound, and imidazole-based compound. These polymerization initiators may be used alone, or by mixing two or more kinds of them. The content thereof is 0.5 to 40 parts by weight, preferably 0.5 to 10 parts by weight relative to 100 parts by weight of the total inclusion material having radical polymerizability in a coating solution solid matter.

In the crosslinked surface layer of the present invention, monofunctional and bifunctional radical polymerizable monomers and a radical polymerizable oligomer can be used together for the purpose of imparting the functions such as viscosity adjustment during coating, stress relaxation of the crosslinked surface layer, lower surface energy and a decrease in a friction coefficient. As these radical polymerizable monomers and the oligomer, known ones can be utilized.

Further, the radical polymerizable hole transportable compound having two or more radical functional groups will be explained in detail. As mentioned above, the radical polymerizable hole transportable compound having two or more radical polymerizable functional groups basically has an aromatic tertiary amine hole transportable structure such as conventionally known triarylamine, hydrazone, pyrazoline and carbazole, and has two or more radical polymerizable groups. For example, JP-A2004-212959 discloses many compounds in Tables 3 to 86, and which can be used in the present invention as well. Particularly, the radical polymerizable group is preferably an acryloyloxy group and a methacryloyloxy group, and they are more preferably bonded with a hole transportable structure through an alkylene chain having two or more, preferably three or more carbon atoms. The above-mentioned defect of the radical polymerizable hole transportable compound having two or more functional groups can be eased.

The crosslinked surface layer of the present invention may include other additives such as a stiffener (a filler improving heat resistance), a dispersion aid and a lubricant besides these components and additives mentioned later unless they spoil the object of the present invention. For example, the crosslinked surface layer may preferably include the stiffener in an amount of 30 parts, and more preferably not greater than 20 parts by weight per 100 parts by weight of the resin unless it spoils the electrical and optical properties of a photoreceptor.

### <Undercoat Layer>

In the photoreceptor of the present invention, an undercoat layer can be provided between then electroconductive substrate (31) and the photosensitive layer (33). The undercoat layer generally contains resins as a main component, and it is desirable that these resins, when it is conceivable that a photosensitive layer is coated thereon with a solvent, have high solvent resistance against general organic solvents. Examples of the resin include curable resins forming a three-dimensional network structure such as water-soluble resins including polyvinyl alcohol, casein and sodium polyacrylate, alcohol-soluble resins including copolymerized nylon and methoxymethylated nylon, polyurethane, amelamine resin, a phenol resin, an alkyd-melamine resin and an epoxy resin.

In addition, fine powdery pigments of metal oxides such as titanium oxide, silica, alumina, zirconium oxide, tin oxide and indium oxide may be added to the undercoat layer for preventing moire, decreasing a residual potential etc. The undercoat layer can be formed using a suitable solvent and coating method as in the aforementioned photosensitive layer. Furthermore, in the undercoat layer of the present invention, a silane coupling agent, a titanium coupling agent, a chromium coupling agent etc. can also be used. In addition, as the undercoat layer of the present invention, an undercoat layer in which Al₂O₃ is provided by anode oxidation, and an undercoat layer in which an organic substance such as polyparaxylylene (parylene) or an inorganic substance such as SiO₂, SnO₂, TiO₂, ITO or CeO₂ is provided by a vacuum film making method can also be suitably used. In addition, known ones can be used. The film thickness of the undercoat layer is suitably 1 to 15 μm.

### <Regarding Addition of Antioxidant to Each Layer>

In the present invention, an antioxidant can be added to each layer of the first charge transport layer, the second charge transport layer, the charge generation layer, the undercoat layer etc. for the purpose of improving environment resistance, inter alia, preventing reduction in sensitivity, and an increase in a residual potential. As the antioxidant to be added, previously known materials can be used, and examples thereof include the followings.

### (Phenol-Based Compound)

2,6-di-t-butyl-t-cresol, butylated hydroxyanisole,
2,6-di-t-butyl-4-ethylphenol,
stearyl-β-(3,5-di-t-butyl-4-hydroxyphenyl)propionate,
2,2′-methylenebis-(4-methyl-6-t-butylphenol),
2,2′-methylenebis-(4-ethyl-6-t-butylphenol),
4,4′-thiobis-(3-methyl-6-t-butylphenol),
4,4′-butylidenebis-(3-methyl-6-t-butylphenol),
1,1,3-tris(2-methyl-4-hydroxy-5-t-butylphenyl)butane,
1,3,5-trimethyl-2,4,6-tris(3,5-di-t-buthyl-4-hydroxybenzyl)benzene,
tetrakis-[methylene-3-(3′,5′-di-t-butyl-4′-hydroxyphenyl)propionate]methane,
bis[3,3′-bis(4′-hydroxy-3′-t-butylphenyl)butyric acid]glycol ester, tocopherols, etc.

### (Paraphenylenediamines)

N-phenyl-N′-isopropyl-p-phenylenediamine,
N,N′-di-sec-butyl-p-phenylenediamine,
N-phenyl-N-sec-butyl-p-phenylenediamine,
N,N′-di-isopropyl-p-phenylenediamine,
N,N′-dimethyl-N,N′-di-t-butyl-p-phenylenediamine, etc.

(Hydroquinones)
2,5-di-t-octylhydroquinone, 2,6-didodecylhydroquinone,
2-dodecylhydroquinone, 2-dodecyl-5-chlorohydroquinone,
2-t-octyl-5-methylhydroquinone,
2-(2-octadecenyl)-5-methylhydroquinone, etc.

### (Organic Sulfur Compounds)

Dilauryl-3,3′-thiodipropionate,
distearyl-3,3′-thiodipropionate,
ditetradecyl-3,3′-thiodipropionate, etc.

### (Organic Phosphorus Compounds)

Triphenylphosphine, tri(nonylphenyl)phosphine,
tri(dinonylphenyl)phosphine, tricresylphosphine,
tri(2,4-dibutylphenoxy)phosphine, etc.

These compounds are known as antioxidants for rubbers, plastics, and oils and fats, and are easily commercially available. The amount of the antioxidant added in the present invention is 0.01 to 10% by weight relative to the total weight of a layer to be added.

### <Regarding Image Forming Method and Apparatus>

Then, the image forming method and image forming apparatus of the present invention will be described in detail based on the drawings. The image forming method and image forming apparatus of the present invention are an image forming method including processes of transfer of a toner image onto an image holding body (transfer paper), fixation and cleaning of a photoreceptor surface, for example, after undergoing at least stages of electrostatic charging of a photoreceptor, image light exposure, and development, using a laminated-type photoreceptor having a crosslinked-type charge transport layer that has very high abrasion resistance and scratch resistance and that hardly generates crack and film peeling at its surface, as well as an image forming apparatus. Optionally, the image forming method of directly transferring an electrostatic latent image onto a material to be transferred, followed by development does not necessarily have the aforementioned processes performed on the photoreceptor.

FIG. 2 is a schematic view illustrating an embodiment of the image forming apparatus of the present invention. As a means for averagely electrostatically charging the photoreceptor, a charger (3) is used. As the electrostatic charging means, a corotron device, a scorotron device, a solid discharging element, a needle electrode device, a roller electrostatic charging device, an electrically conductive brush device etc. are used, and known systems can be used. Particularly, the constitution of the present invention is particularly effective when an electrostatic charging means in which close discharge from an electrostatic charging means which becomes a cause for degradation of a photoreceptor composition is generated, such as a contact electrostatic charging system or a non-contact close arrangement electrostatic charging system is used. The contact electrostatic charging referred herein is an electrostatic charging system in which an electrostatic charging roller, an electrostatic charging brush, an electrostatic charging blade or the like is directly contacted with a photoreceptor. On the other hand, the close electrostatic charging system is, for example, a system in which an electrostatic charging roller is closely arranged in the non-contact state, so that a gap of 200 μm or less is possessed between a photoreceptor surface and an electrostatic charging means.

When the gap is too great, electrostatic charging easily becomes unstable and, on the other hand, when the gap is too small, there is a possibility that an electrostatic charging member surface is stained in a case where a remaining toner is present on the photoreceptor. Therefore, the gap is suitably in the range of 10 to 200 μm, preferably 10 to 100 μm.

Then, in order to form an electrostatic latent image on the uniformly electrostatically charged photoreceptor (1), an irradiator (5) is used. For this light source, general light emitting products such as a fluorescent lamp, a tungsten lamp, a halogen lamp, a mercury lamp, a sodium lamp, a light emitting diode (LED), a semiconductor laser (LD), and an electroluminescence (EL) can be used. In order to irradiate only light having a desired wavelength region, various filters such as a sharp cutting filter, a band pass filter, a near infrared cutting filter, a dichroic filter, an interference filter and a color temperature converting filter can also be used.

Then, in order to visualize the electrostatic latent image formed on the photoreceptor (1), a developing unit (6) is used. As a developing system, there are a one-component developing method and a two-component developing method using a dry toner, and a wet developing method using a wet toner. When the photoreceptor is positively (negatively) charged, and image light exposure is performed, a positive (negative) electrostatic latent image is formed on the photoreceptor surface. When it is developed with a toner (detecting fine particle) having negative (positive) polarity, a positive image is obtained and, when developed with a toner having positive (negative) polarity, a negative image is obtained.

Then, in order to transfer a toner image visualized on the photoreceptor onto a material to be transferred (9), a transfer charger (10) is used. In addition, in order to conduct transfer better, a pre-transfer charger (7) may be used. As these transfer means, an electrostatic transfer system, a pressure-sensitive adhesive transfer method, a mechanical transfer system such as a pressure transfer method, and a magnetic transfer system using a transfer charger, or a bias roller can be utilized. As the electrostatic transfer system, the aforementioned electrostatic charging means can be utilized.

Then, as a means for separating the material to be transferred (9) from the photoreceptor (1), a separation charger (11) and a separation nail (12) are used. As other separation means, electrostatic adsorption inducing separation, side end belt separation, tip grip conveyance, a curvature separation etc. are used. As the separation charger (11), the same system as that for the aforementioned electrostatic charging means can be utilized. Then, in order to clean a toner remaining on the photoreceptor after transfer, a fur brush (14) and a cleaning blade (15) are used.

In addition, in order to conduct transfer better, a pre-transfer charger (13) may be used. Alternatively, in order to perform cleaning more effectively, a pre-cleaning charger (13) may be used. As other cleaning means, there are a web system, a magnetic brush system etc., and they may be used alone, or a plurality of systems may be used together. Then, if necessary, a neutralization means is used for the purpose of removing a latent image on the photoreceptor. As the neutralization means, a neutralization lamp (2), and a neutralization charger are used, and the exposing light source, and the electrostatic charging means can be utilized, respectively. In addition, as processes such as reading of manuscript which is not close to the photoreceptor, paper supply, fixation, paper discharge etc., known ones can be used.

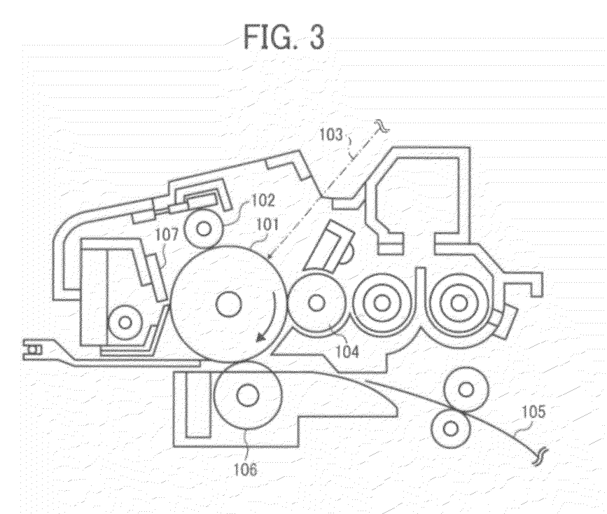

The present invention is the image forming method and image forming apparatus using the electrophotographic photoreceptor related to the present invention in the image forming means. This image forming means may be incorporated into a copying apparatus, a facsimile or a printer by fixation, or may be incorporated into those apparatuses in a form of a process cartridge, so that it is detachable. An embodiment of the process cartridges is shown in FIG. 3.

The process cartridge for an image forming apparatus is an apparatus (part) which has a built-in photoreceptor (101) and, additionally, is provided with at least one of an electrostatic charging means (102), a developing means (104), a transfer means (106), a cleaning means (107), and a neutralization means (not shown), and is detachable from the image forming apparatus body. An image forming process by the apparatus exemplified in FIG. 3 will be shown; while the photoreceptor (101) is rotated in an arrow direction, electrostatic charging with the electrostatic charging means (102) and light exposure with a light exposing means (103) form an electrostatic latent image corresponding to a light exposed image on a surface thereof, this electrostatic latent image is toner-developed with the developing means (104), the toner development is transferred onto a transfer body (105) with the transfer means (106), and is printed out. Then, a surface of the photoreceptor after image transfer is cleaned with the cleaning means (107) and, further, is neutralized with a neutralization means (not shown), and the above procedures are repeated, again.

The present invention provides the process cartridge for an image forming apparatus, in which a laminated-type photoreceptor having, on a surface thereof, a crosslinked-type charge transport layer having very high abrasion resistance and scratch resistance, and in which crack and film pealing are generated with difficulty, and at least one of an electrostatic charging means, a developing means, a transfer means, a cleaning means, and a neutralization means is incorporated. As apparent from the above explanation, the electrophotographic photoreceptor of the present invention not only can be utilized in an electrophotographic copying machine, but also can be widely used in the electrophotographic application field such as a laser beam printer, a CRT printer, a LED printer, a liquid crystal printer and a laser plate making.

Details of the measuring method of the present invention will be described.

<Measurement of Elastic Displacement Rate with Surface Microhardness Tester>

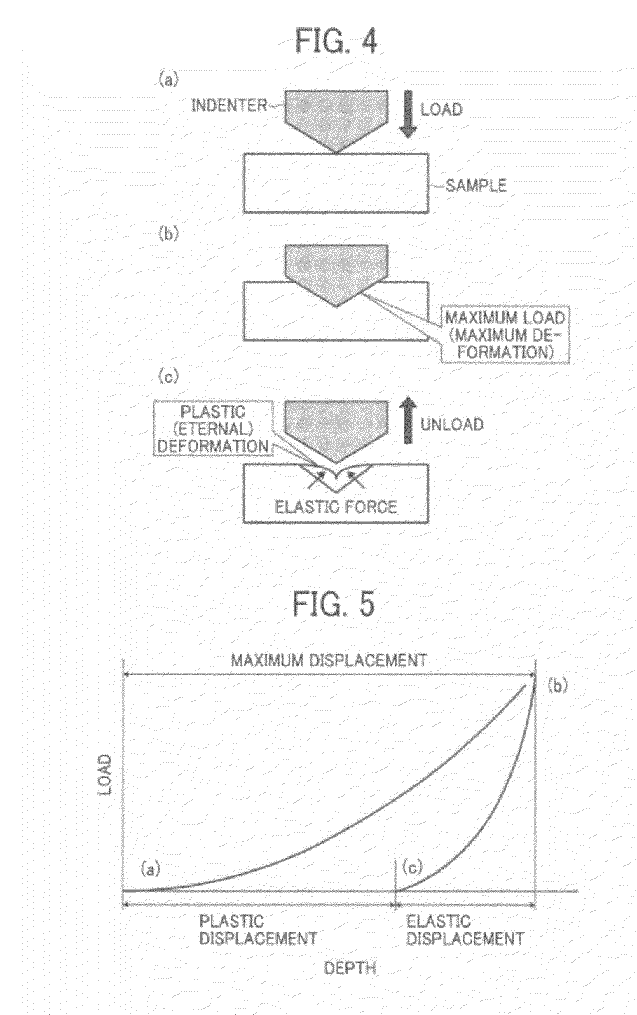

An elastic displacement rate τe in the present invention is measured by a loading-unloading test with a surface microhardness tester using a diamond indenter. As shown in FIG. 4, from a point (a) at which the indenter is contacted with a sample, the indenter is compressed in the sample at a constant loading rate (loading process), the indenter is rested for a constant time at a maximum displacement (b) at which a load reaches a set load and, further, the indenter is pulled up at a constant unloading rate (unloading process), and a point at which a load finally begins not to be applied to the intender is defined as plastic displacement (c). Thereupon, the resulting compression depth and a load curve are recorded as in FIG. 5, and an elastic displacement rate τe is calculated by the following equation, from a maximum displacement (b) and a plastic displacement (c).

Elastic displacement rate τe(%)=[(maximum displacement)−(plastic displacement)]/(maximum displacement)×100

The elastic displacement rate measurement is performed under constant temperature and humidity, and the elastic displacement rate in the present invention shows a measured value of the test which was conducted under the environmental condition of a temperature of 22° C. and a relative humidity of 55%.

In the present invention, a dynamic surface microhardness tester DUH-201 (manufactured by Shimadzu Corporation), and a trigonal pyramid indenter (115°) are used, but any value measured with any apparatus having the equal performance may be used. An elastic displacement rate τe was measured regarding arbitrary 10 places on a sample, and a standard deviation of an elastic displacement rate τe was calculated from this ten values. In measurement, the photoreceptor having a crosslinked surface layer of the present invention was manufactured on an aluminum cylinder, and this was appropriately cut, and used. Since an elastic displacement rate τe undergoes influence of spring property of a substrate and, as the substrate, a rigid metal plate, and a slide glass are suitable. Further, since elements of a hardness and an elasticity of a lower layer (e.g. charge transport layer, charge generation layer, etc.) of the crosslinked surface layer also influence, a prescribed load was adjusted so that a maximum displacement became 1/10 a film thickness of the crosslinked surface layer, in order to decrease these influences. When only the crosslinked surface layer alone is manufactured on the substrate, since mixing in of lower layer components, and adherability with the lower layer are changed, and the surface crosslinked layer of the photoreceptor cannot be necessarily reproduced precisely, this is not preferable.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example 1

A coating solution for an undercoat layer, a coating solution for a charge generation layer, and a coating solution for a hole transport layer having the following compositions were sequentially immersion-coated on an aluminum cylinder of φ60 mm having a polished surface, and dried to form a 3.5 μm undercoat lay hole transport layer. A coating solution including a radical polymerizable hole transportable compound and a silole compound in an amount of 5% by weight based on the weight of the radical polymerizable hole transportable compound for a hole transportable protection t layer was spray-coated on this hole transport layer, and spontaneously dried for 20 minutes, and light irradiation was performed under the conditions of a metal halide lamp: 160 W/cm, an irradiation distance: 120 mm, an irradiation intensity: 500 mW/cm², and an irradiation time: 180 seconds, to cure a coated film. Further, drying at 130° C. for 30 minutes was added to provide a 4.0 μm hole transportable protection layer, thereby, the electrophotographic photoreceptor of the present invention was manufactured.

[Coating solution for undercoat layer]

| | |
|---|---|
| Alkyd resin | 6 parts |
| (Beckosol 1307-60-EL, manufactured by DIC Corporation) | |
| Melamine resin | 4 parts |
| (Super Beckamine G-821-60, manufactured by DIC | |
| Corporation) | |
| Titanium oxide | 50 parts |
| Methyl ethyl ketone | 50 parts |

[Coating solution for charge generation layer]

| | | |
|---|---|---|
| Titanyl phthalocyanine | 1.5 | parts |
| Polyvinyl butyral | 0.5 | part |
| (XYHL, manufactured by UCC) | | |
| Cyclohexanone | 200 | parts |
| Methyl ethyl ketone | 80 | parts |

[Coating solution for hole transport layer]

| | | |
|---|---|---|
| Bisphenol Z polycarbonate | 10 | parts |
| (Panlite TS-2050, manufactured by Teijin Chemicals LTD.) | | |
| Hole transport material having the following formula | 10 | parts |
| (HTM-1) | | |
| 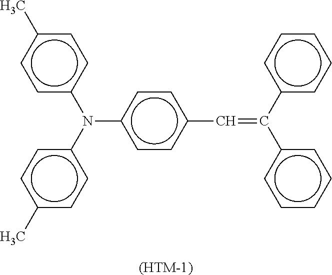 | | |
| Tetrahydrofuran | 100 | parts |
| Tetrahydrofuran solution of 1% silicone oil | 0.2 | part |
| (KF50-100CS, manufactured by Shin-Etsu Chemical Co., | | |
| Ltd.) | | |
| Antioxidant BHT | 0.2 | part |

[Coating solution for hole transportable protection layer]

| | | |
|---|---|---|
| Multifunctional radical polymerizable monomer | 10 | parts |
| Trimethylolpropane triacrylate (KAYARAD TMPTA, manufactured by | | |
| Nippon Kayaku Co., Ltd.) molecular weight: 296, | | |
| functional group number: trifunctional, | | |
| molecular weight/functional group number = 99 | | |
| Radical polymerizable hole transportable compound having the | 10 | parts |
| following formula (RHTM-1) | | |
| 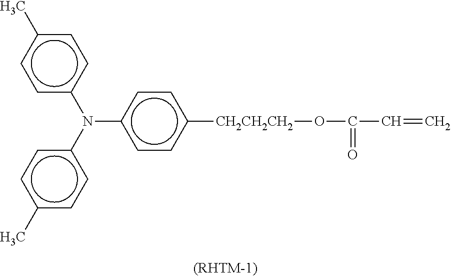 | | |
| Photopolymerization initiator | 1 | part |
| 1-hydroxy-cyclohexyl-phenyl-ketone | | |
| (IRGACURE 184, manufactured by Ciba Specialty Chemicals) | | |
| Silole compound | 0.5 | part |
| Embodiment No.1 compound | | |
| Tetrahydrofuran | 100 | parts |

### Example 2

The procedure for preparation of the electrophotographic photoreceptor in Example 1 was repeated except for replacing the hole transport material (HTM-1), the radical polymerizable hole transportable compound (RHTM-1) and the silole compound with a hole transport material having the following formula (HTM-2), a radical polymerizable hole transportable compound having the following formula (RHTM-2) and Embodiment No. 2 compound, respectively.

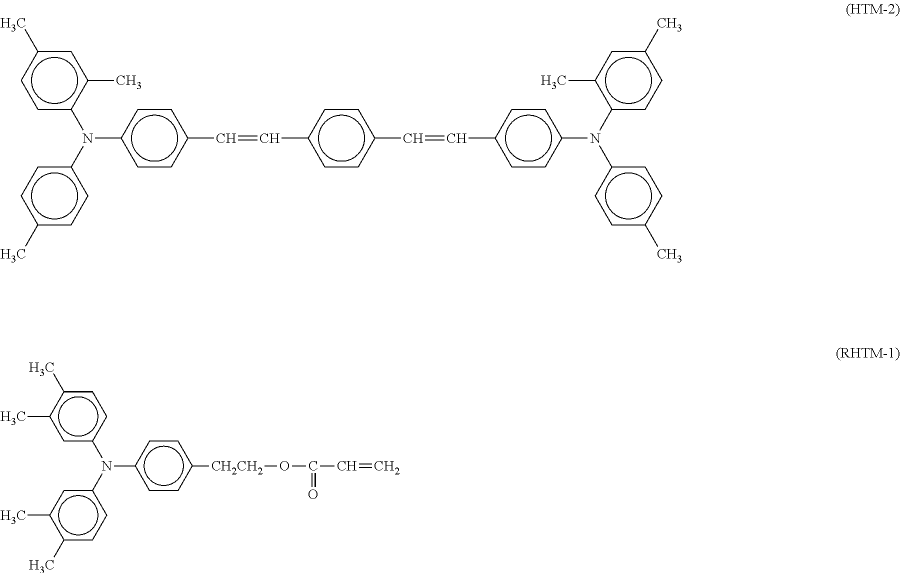

### Example 3

The procedure for preparation of the electrophotographic photoreceptor in Example 2 was repeated except for replacing the radical polymerizable hole transportable compound (RHTM-2) and the silole compound with a radical polymerizable hole transportable compound having the following formula (RHTM-3) and Embodiment No. 3 compound, respectively.

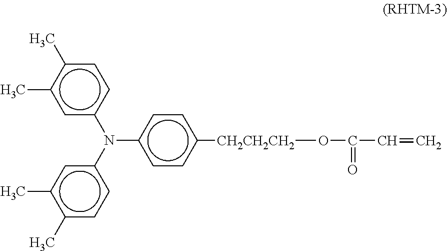

### Example 4

The procedure for preparation of the electrophotographic photoreceptor in Example 1 was repeated except for using a hole transportable protection layer coating solution having the following formulation.

[Coating solution for hole transportable protection layer]

| | | |
|---|---|---|
| Multifunctional radical | 5 | parts |
| polymerizable monomer (1) | | |
| Trimethylolpropane triacrylate (KAYARAD TMPTA, | | |
| manufactured by Nippon Kayaku Co., Ltd.) molecular weight: 296, | | |
| functional group number: trifunctional, molecular weight/functional group number = :99 | | |
| Multifunctional radical | 5 | parts |
| polymerizable monomer (2) | | |
| Caprolactone-modifed dipentaerythritol hexaacrylate | | |
| (KAYARAD DPCA-120 from Nippon Kayaku Co., Ltd.) molecular weight: 1947, | | |
| functional group number: six functional groups, | | |
| molecular weight/functional group number = :325 | | |
| Radical polymerizable hole | 10 | parts |
| transportable compound having the following formula (RHTM-4) | | |
| 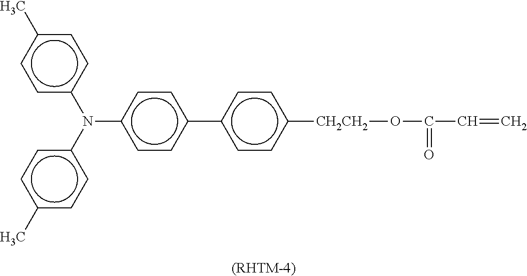 | | |
| Photopolymerization initiator | 1 | part |
| 1-hydroxy-cyclohexyl-phenyl-ketone | | |
| (IRGACURE 184, manufactured by Ciba Specialty Chemicals) | | |
| Silole compound | 0.5 | part |
| Embodiment No.4 compound | | |
| Tetrahydrofuran | 100 | parts |
| Tetrahydrofuran solution of 1% silicone oil | 0.2 | part |
| (KF50-100CS, manufactured by Shin-Etsu Chemical Co., Ltd.) | | |

### Example 5

The procedure for preparation of the electrophotographic photoreceptor in Example 4 was repeated except for changing the content of the silole compound No. 4 into 0.3% by weight per 100% by weight of the radical polymerizable hole transportable compound (RHTM-4).

### Example 6

The procedure for preparation of the electrophotographic photoreceptor in Example 4 was repeated except for changing the content of the silole compound No. 4 into 0.5% by weight per 100% by weight of the radical polymerizable hole transportable compound (RHTM-4).

### Example 7

The procedure for preparation of the electrophotographic photoreceptor in Example 4 was repeated except for changing the content of the silole compound No. 4 into 1% by weight per 100% by weight of the radical polymerizable hole transportable compound (RHTM-4).

### Example 8

The procedure for preparation of the electrophotographic photoreceptor in Example 4 was repeated except for changing the content of the silole compound No. 4 into 10% by weight per 100% by weight of the radical polymerizable hole transportable compound (RHTM-4).

### Example 9

The procedure for preparation of the electrophotographic photoreceptor in Example 4 was repeated except for changing the content of the silole compound No. 4 into 15% by weight per 100% by weight of the radical polymerizable hole transportable compound (RHTM-4).

### Comparative Examples 1 to 4

The procedures for preparation of the electrophotographic photoreceptors in Examples 1 to 4 were repeated except for excluding the silole compound.

### Comparative Example 5

The procedure for preparation of the electrophotographic photoreceptors in Example 1 was repeated except for replacing the silole compound with an UV absorber having the following formula (UV-1).

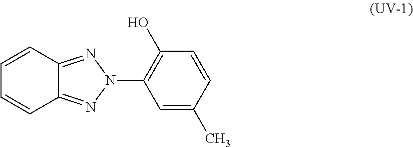

### Comparative Example 6

The procedure for preparation of the electrophotographic photoreceptors in Example 1 was repeated except for replacing the silole compound with an UV absorber having the following formula (UV-2).

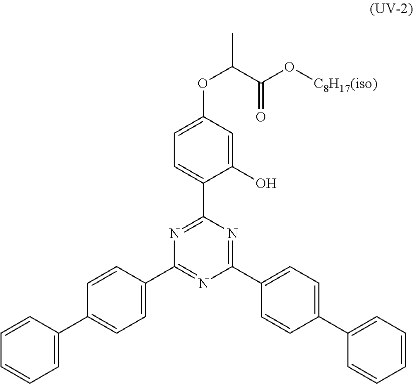

### Comparative Example 7

The procedure for preparation of the electrophotographic photoreceptors in Example 1 was repeated except for replacing the silole compound with an electron transferer having the following formula (ETM-1).

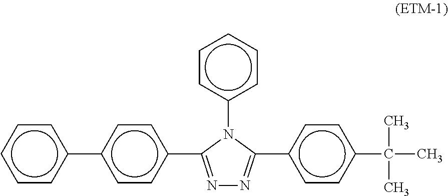

### Comparative Example 8

The procedure for preparation of the electrophotographic photoreceptors in Example 1 was repeated except for replacing the silole compound with an electron transferer having the following formula (ETM-2).

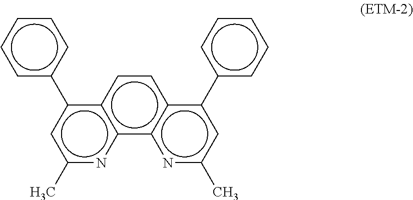

### Comparative Example 9

The procedure for preparation of the electrophotographic photoreceptors in Example 1 was repeated except for replacing the silole compound with a silole electron transferer having the following formula and a different structure from that of the present invention (ETM-3).

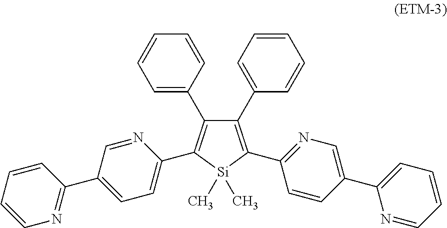

### Comparative Example 10

The procedure for preparation of the electrophotographic photoreceptors in Example 1 was repeated except for replacing the silole compound with a singlet oxygen quencher having the following formula (Q-1).

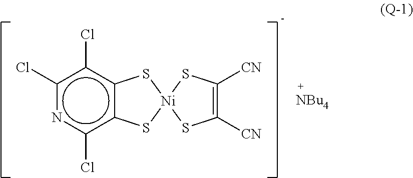

### <Charge Trap Inhibitive Effect of Silole Compound>

A charge trap generated in a protection layer delays and stops hole transportation, resulting in deterioration of sensitivity and increase of residual potential of the photoreceptor. When a photoreceptor negatively charged to have the same potential is irradiated, a hole generated in a charge generation layer travels through a hole transport layer and a hole transportable protection layer and reaches the surface of the photoreceptor to eliminate the surface potential.

As the surface potential is eliminated, an electric field applied to a photosensitive layer becomes small and the hole gradually travels slow, and the surface potential does not decrease anymore. The potential then is defined as a saturated potential. When a charge trap is generated in the hole transportable protection layer, the surface potential does not decrease therefor and the saturated potential becomes high. Therefore, the saturated potential was examined to evaluate whether generation of a charge trap is prevented.

The electrophotographic photoreceptors prepared in Examples 1 to 4 and Comparative Examples 1 to 4 were charged by a scorotron charger to have a potential of −800 V and irradiated by a laser diode having a wavelength of 65 nm, an aperture 70×80 μm and an image resolution of 400 dpi while rotated at a linear speed of 160 mm/sec. The surface potential of the photoreceptor was measured 80 msec after the irradiation. The surface potential is not decreased at a specific light amount or more when the irradiation light amount is gradually increased. This time, the surface potential when a light amount 1 μJ/cm2 which is enough to saturate is irradiated was measured as a saturated potential. The results are shown in Table 2

TABLE 2

Saturated
Potential (−V)

Example 1
Example 2
Example 3
Example 4
Comparative
Example 1
Comparative
Example 2
Comparative
Example 3
Comparative
Example 4

The electrophotographic photoreceptors including the silole compound have less saturated potential than the electrophotographic photoreceptors excluding the silole compound. This proves the silole compound prevents a charge trap from generating.

### <Influence of Content of Silole Compound>

The silole compound for use in the present invention doe not have hole transportability and radical reactivity.

Therefore, when the content thereof is too large, the hole transportability and mechanical strength are thought to deteriorate. When too small, the effect of preventing charge traps is thought to become less. Therefore, the content thereof is thought to have a suitable range. In order to find the suitable range, the saturated potential of the electrophotographic photoreceptor and an elasticity variation rate τe, which is an index for mechanical strength thereof were measured. The saturated potential of the electrophotographic photoreceptors prepared in Examples 5 to 9 and Example 4 and the elasticity variation rate τe thereof measured by the surface microhardness tester are shown in Table 3.

TABLE 3

| | | Saturated | Elasticity |
|---|---|---|---|
| | Content (%) | potential (−V) | variation rate |
| Example 5 | 0.3 | 127 | 43 |
| Example 6 | 0.5 | 110 | 42 |
| Example 7 | 1 | 95 | 42 |
| Example 4 | 5 | 89 | 41 |
| Example 8 | 10 | 80 | 39 |
| Example 9 | 15 | 81 | 35 |
| Comparative | 0 | 129 | 45 |
| Example 4 | | | |

Table 3 proves the saturated potential depends on the content of the silole compound in a specific range. When the content is less than 0.5% by weight, the saturated potential scarcely changes and the effect of charge trap prevention is almost none. When not less than 10% by weight, the saturated potential does not decrease any more, which is excessive.

The elasticity variation rate decreases as the content increases. This proves an additive having no radical reactivity decrease the crosslink density. However, when the additive is included in an amount not greater than 10%, the elasticity variation rate is not less than 40% and the resultant photoreceptor has more mechanical strength than a photoreceptor having no protection layer. However, when greater than 10%, the, the elasticity variation rate is less than 40% and the protection layer does not have sufficient strength.

Therefore, a protection layer having good charge transportability with less charge trap while having mechanical strength includes a silole compound in an amount of from 0.5 to 10% by weight based on total weight of a radical polymerizable hole transportable compound.

### <Influence Upon Variation of Inner Potential and Uneven Image Density in Continuous Image Production>

A specific silole compound can reduce charge trap generation in a protection layer. An effect there of in actual image production was evaluated.

Each of the electrophotographic photoreceptors prepared in Examples 1 to 4 and Comparative Examples 1 to 4 was installed in a process cartridge of a digital full-color complex machine MP C7500 SP from Ricoh Company, Ltd., continuous each yellow, magenta, cyan and black 500 halftone images were produced at 60 pieces/min on A4 Ricoh My Recycle Paper GP at 600×600 dpi. Image density of the first to fifth and 495th to 500th black images were visually compared. Image density of the first and 500th halftone (1 by 1 dot black image) were measured by Macbeth densitometer. Five parts of one image were measured and averaged.

Rank 5: No uneven image density

Rank 4: Almost no uneven image density

Rank 3: Some images have slight uneven image density

Rank 2: All images have slight uneven image density

Rank 1: All images have distinct uneven image density

The results are shown in Table 4

TABLE 4

| | First to | 495th to | | | |
|---|---|---|---|---|---|
| | fifth | 500th | | | |
| | Uneven | Uneven | First | 500^{th} | Difference |
| | image | image | image | image | of image |
| | density | density | density | density | density |
| Example 1 | 5 | 4 | 0.458 | 0.445 | 0.013 |
| Example 2 | 5 | 5 | 0.462 | 0.454 | 0.008 |
| Example 3 | 5 | 5 | 0.455 | 0.448 | 0.007 |
| Example 4 | 5 | 5 | 0.457 | 0.451 | 0.006 |
| Comparative | 4 | 3 | 0.458 | 0.433 | 0.025 |
| Example 1 | | | | | |
| Comparative | 4 | 3 | 0.459 | 0.431 | 0.028 |
| Example 2 | | | | | |
| Comparative | 4 | 3 | 0.459 | 0.435 | 0.024 |
| Example 3 | | | | | |
| Comparative | 4 | 3 | 0.455 | 0.430 | 0.025 |
| Example 4 | | | | | |

The electrophotographic photoreceptor of the present invention can produce high-quality images with less uneven image density. This is maintained as well even after a large amount of images are produced at high speed. The image density variation between the first and the 500th halftone images is apparently small, which proves images having stable quality can continuously be produced. This depends not on the saturated potential but on the additive, which proves a charge trap in a protection layer causes image density variation and uneven image density as time passes.

Therefore, the electrophotographic photoreceptor of the present invention including a specific silole compound to prevent charge trap generation is effectively used for an image forming method, an image forming apparatus and a process cartridge therefor.

<Comparison with Other Additives>

The silole compound having a specific structure of the present invention has an important function of preventing the radical polymerizable hole transportable compound from resolving when irradiated with UV. An UV absorber known to have a similar function is compared therewith. In addition, the silole compound is well known as an electron transport material. An UV absorber known to have a similar function is compared therewith. Further, a singlet oxygen quencher preventing a colorant from discoloring is compared therewith as well.

The saturated potentials of the photoreceptors prepared in Comparative Examples 5 to 10 were measured as above. The results are shown in Table 5.

TABLE 5

| | Saturated potential (−V) |
|---|---|
| Comparative Example 5 | 251 |
| Comparative Example 6 | 234 |
| Comparative Example 7 | 222 |
| Comparative Example 8 | 646 |
| Comparative Example 9 | 240 |
| Comparative Example 10 | 761 |

Compared with Comparative Example 1, some has larger saturated potentials rather than reduced potentials, which is an adverse effect against charge transportability. These prove an effect of the silole compound having a specific structure for use in the present invention is special.

This application claims priority and contains subject matter related to Japanese Patent Application No. 2010-170508 filed on Jul. 29, 2010, the entire contents of which are hereby incorporated by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. An electrophotographic photoreceptor, comprising:
an electroconductive substrate;
a charge generation layer overlying the substrate;
a hole transport layer overlying the charge generation layer; and
a hole transportable protection layer overlying the hole transport layer, the transportable protection layer being a three-dimensional crosslinked film formed by irradiating at least a radical polymerizable hole transportable compound with UV to be chain-polymerized,
wherein the hole transportable protection layer comprises a silole compound having the following formula (I): 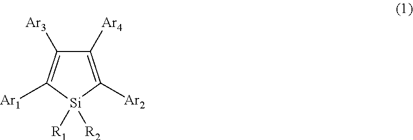
wherein each of R₁ and R₂ represents a monovalent alkyl group having 1 to 4 carbon atoms or a monovalent phenyl group; Each of Ar1 to Ar4 represents a phenyl group, a naphtyl group and a biphenylyl group or a phenyl group, a naphtyl group and a biphenylyl group substituted with a monovalent alkyl group having 1 to 4 carbon atoms and a trifluoromethyl group; and R₁, R₂ and Ar₁ to Ar₄ adjacent to each other optionally connect with each other to form rings.

2. The electrophotographic photoreceptor of claim 1, wherein in the hole transportable protection layer comprises a silole in an amount of form 0.5 to 10% by weight based on total weight of the radical polymerizable hole transportable compound.

3. The electrophotographic photoreceptor of claim 1, wherein the radical polymerizable hole transportable compound comprises an acryloyloxy group as a polymerizable reaction group.

4. An image forming method of repeating steps, comprising:
charging the photoreceptor according to claim 1;
irradiating the photoreceptor to form an electrostatic latent image thereon;
developing the electrostatic latent image with a toner to form a toner image; and
transferring the toner image onto a transfer paper.

5. An image forming apparatus, comprising:
the photoreceptor according to claim 1;
a charger configured to charge the photoreceptor;
an irradiator configured to irradiate the photoreceptor to form an electrostatic latent image thereon;
an image developer configured to develop the electrostatic latent image with toner to form a toner image; and
a transferer configured to transfer the toner image onto a transfer paper.

6. A process cartridge for an image forming apparatus, detachable therefrom, comprising:
the photoreceptor according to claim 1; and
at least one of a charger, an image developer, a transferer, a cleaner and a discharger.
